(19) United States
(12) Patent Application Publication
(10) Pub. No.: US 2004/0184589 A1
(43) Pub. Date: Sep. 23, 2004

(54) Terminal information registration apparatus, terminal information registration method and terminal information registration program

(75) Inventors: Yutaka Tamada, Tokyo (JP); Osamu Tachiyama, Tachikawa-shi (JP); Tsuneo Kohari, Mishima-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/801,712

(22) Filed: Mar. 17, 2004

(30) Foreign Application Priority Data
Mar. 18, 2003 (JP) 2003-074237

(51) Int. Cl. H04M 15/00

(52) U.S. Cl. 379/121.06

(57) ABSTRACT

A terminal information registration apparatus includes a communication module connected to a center server by Internet, and a registration module that registers management object terminal information into the center server via the communication module. Particularly, the registration module is configured to set a provisional access code issued to an authorized user into the communication module and establish a communication for registering terminal identification information of one or more electronic office terminals as the management object terminal information.

### CROSS-REFERENCE TO RELATED APPLICATIONS

This application is based upon and claims the benefit of priority from prior Japanese Patent Application No. 2003-074237, filed Mar. 18, 2003, the entire contents of which are incorporated herein by reference.

### BACKGROUND OF THE INVENTION

1. Field of the Invention

The present invention relates to a terminal information registration apparatus, terminal information registration method and terminal information registration program that register terminal information of an electronic office terminal such as a copier or a multifunction peripheral having various functions into a terminal management apparatus via a communication network.

2. Description of the Related Art

In recent years, with the development of the network technology represented by Internet, the running statuses of electronic office terminals such as copiers or multifunction peripherals having various functions can be remotely managed at a service base of a manufacturer after the terminals have been installed on the client side. The remote management is performed for consumables supply and lease charging, for example.

As a terminal management apparatus, a center server is installed at the service base of the manufacturer. The center server is connected to the electronic office terminals installed in a plurality of client locations via a communication network such as Internet. Upon request from the center server, each electronic office terminal registers running status information thereof into the center server as terminal information.

For example, when a plurality of electronic office terminals are newly installed in the conventional case, a serviceperson of the dealer who is in charge of installation confirms terminal identification information such as the serial numbers and the model names of the electronic office terminals on the client side, write down the terminal identification information in a document. After getting back to a dealer office, the serviceperson registers the document contents in a dealer site provided on Internet by the center server and, as a result, acquires passwords issued for all of the electronic office terminals. Thereafter, the serviceperson enters the passwords into the respective electronic office terminals in the client locations to make a communication for registering terminal identification information having the password attached thereto into the center server as terminal information. In this case, the center server confirms the validity of the terminal information based on the attached password (for example, refer to Jpn. Pat. Appln. KOKAI Publication No. 7-58866).

However, in the conventional procedure described above, an error may occur at the stages of confirming, writing, and registering terminal identification information and at the stage of entering a password, and a loss of the terminal identification information or the password also may occur. Therefore, it becomes necessary to uselessly go back and forth between the client location and the dealer office in order to acquire the password again. In a procedure of re-acquiring the password, it is necessary to update the terminal identification information which is already dealt with as a management object by the center server. Therefore, a new error may occur in the updating operation. Further, the center server is required to be configured so as to cope with updating of the terminal identification information. In addition, even if an error or missing does not occur at the entry stage of the password, the serviceperson must go back and forth between the client location and the dealer office at least twice and the load on the serviceperson becomes heavy.

### BRIEF SUMMARY OF THE INVENTION

An object of this invention is to provide a terminal information registration apparatus, terminal information registration method and terminal information registration program which can eliminate a failure occurring in the process of registering terminal identification information of an electronic office terminal.

According to this invention, there is provided a terminal information registration apparatus comprising a communication module connected to a terminal management apparatus by a communication network, and a registration module which registers management object terminal information into the terminal management apparatus via the communication module, the registration module being configured to set a provisional access code issued to an authorized user into the communication module and establish a communication for registering terminal identification information of one or more electronic office terminals as the management object terminal information.

Further, according to this invention, there is provided a terminal information registration method which connects a communication module to a terminal management apparatus by a communication network and registers management object terminal information into the terminal management apparatus via the communication module, the method comprising setting a provisional access code issued to an authorized user into the communication module and establishing a communication for registering terminal identification information of one or more electronic office terminals as the management object terminal information.

Further, according to this invention, there is provided a terminal information registration program which is executed by a registration module incorporated together with a communication module into a server computer connected to one or more electronic office terminals by a local area network to connect the communication module to a terminal management apparatus by a communication network and operate the registration module to register management object terminal information into the terminal management apparatus via the communication module, the program comprising setting a provisional access code issued to an authorized user into the communication module, and establishing a communication for registering terminal identification information of the one or more electronic office terminals as the management object terminal information.

In the terminal information registration apparatus, terminal information registration method and terminal information registration program, the terminal identification information of the one or more electronic office terminals is registered into the terminal management apparatus as the management object terminal information in the communication established by the provisional access code. Since the provisional access code is issued to the authorized user, the serviceperson of the dealer can newly acquire or re-acquire the provisional access code simply by registering the authorized user and does not have to deal with the terminal identification information of each electronic office terminal. Therefore, a failure occurring in the process of registering the terminal identification information can be eliminated.

Further, terminal identification information can be registered for a plurality of electronic office terminals simply by acquiring one provisional access code. Therefore, even when the number of electronic office terminals is extremely large, it will not impose a heavy load on the serviceperson of the dealer in charge of installation. Further, even when the provisional access code is lost before installation of the electronic office terminals, the terminal identification information of the electronic office terminals is not registered as the management object terminal information in the terminal management apparatus at this time point. Therefore, the terminal management apparatus is not required to perform a process relating to the terminal identification information even when the provisional access code is lost.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view schematically showing the configuration of a remote management system according to a first embodiment of this invention;

FIG. 2 is a diagram showing an example of the circuit configuration of an electronic office terminal shown in FIG. 1;

FIG. 3 is a diagram showing an example of the circuit configuration of an on-site server shown in FIG. 1;

FIG. 4 is a diagram showing the flow of a process for acquiring a formal password in the remote management system shown in FIG. 1;

FIG. 5 is a view schematically showing the configuration of a remote management system according to a second embodiment of this invention;

FIG. 6 is a diagram showing an example of the circuit configuration of an electronic office terminal shown in FIG. 5; and

FIG. 7 is a diagram showing the flow of a process for acquiring a formal password in the remote management system shown in FIG. 5.

### DETAILED DESCRIPTION OF THE INVENTION

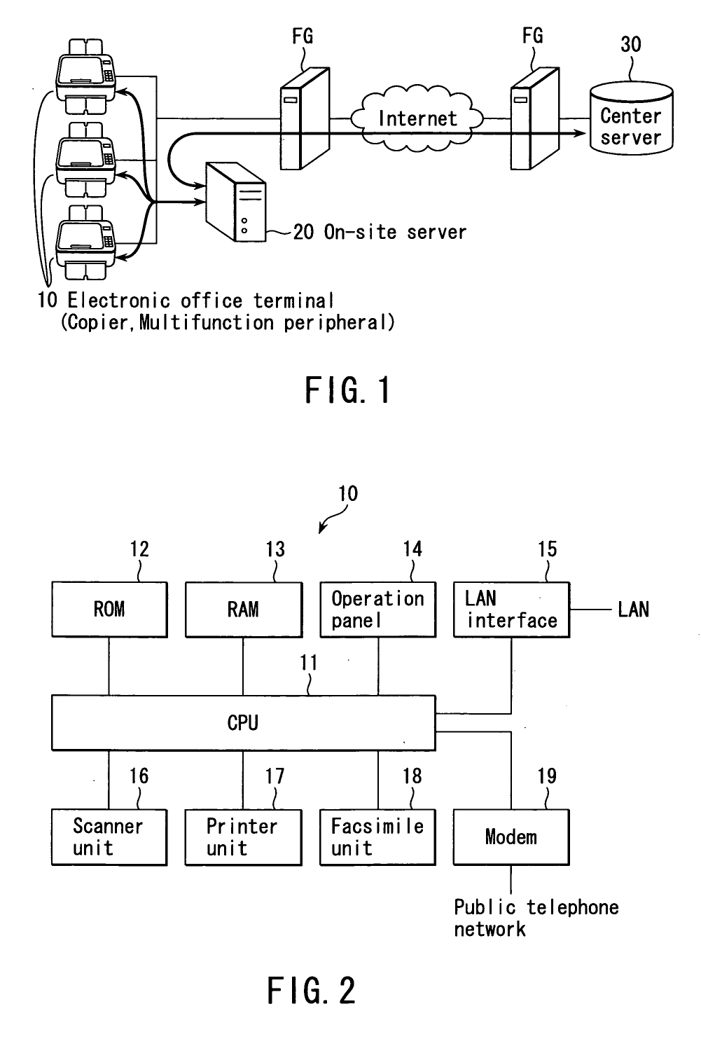

A remote management system according to a first embodiment of this invention will be described below with reference to FIGS. 1 to 4. The remote management system allows the running statuses of one or more electronic office terminals installed on each client side to be remotely managed at the service base of the manufacturer for consumables supply and lease charging according to the accumulative number of operations, for example.

FIG. 1 schematically shows the configuration of the remote management system. In FIG. 1, a plurality of electronic office terminals 10 and a single on-site server 20 are installed on the client side and a center server 30 is installed at the service base of the manufacturer. The electronic office terminals 10 correspond to copiers or multifunction peripherals having various functions, for example. The on-site server 20 is a computer installed to provide a web site. The electronic office terminals 10 and on-site server 20 are commonly used on a local area network (LAN) and connected via a firewall gateway FG to Internet used as a communication network. The center server 30 is a server computer that manages the running statuses of the electronic office terminals 10 and is connected via a firewall gateway FG to Internet in the same manner as the client side. Further, the on-site server 20 functions to collect running status information items of all the electronic office terminals 10 upon request from the center server 30 and register the running status information items in the center server 30. The above function is attained by execution of a terminal information registration program incorporated as application software.

FIG. 2 shows an example of the circuit configuration of the electronic office terminal 10. The electronic office terminal 10 is configured as a multifunction peripheral having a combination of a scanner function, printer function and facsimile function. Further, the terminal 10 includes a CPU 11, ROM 12, RAM 13, operation panel 14, LAN interface 15, scanner unit 16, printer unit 17, facsimile unit 18 and modem 19. The CPU 11 performs a control process to control the whole operation of the electronic office terminal 10. The ROM 12 stores fixed data and a control program of the CPU 11 and the RAM 13 temporarily stores input and output data of the CPU 11. The operation panel 14 is integrally configured to contain an input pad for inputting various commands and data required for the control process and a display for displaying various messages and input results. The LAN interface 15 is an interface that connects the CPU 11 to the LAN and makes data communication with the on-site server 20 or the like via the LAN. The scanner unit 16 captures an image of an original and outputs data corresponding to the original image. The printer unit 17 prints characters and images corresponding to data obtained from the scanner unit 16 or data obtained via the LAN, for example. The facsimile unit 18 converts data obtained from the scanner unit 16 to a facsimile signal to be transmitted by the modem 19, for example, and converts a facsimile signal received by the modem 19 to data to be printed by the printer unit 17. The modem 19 is an interface that connects the facsimile unit 18 and CPU 11 to the public telephone network, for example, and makes data communication via the public telephone network.

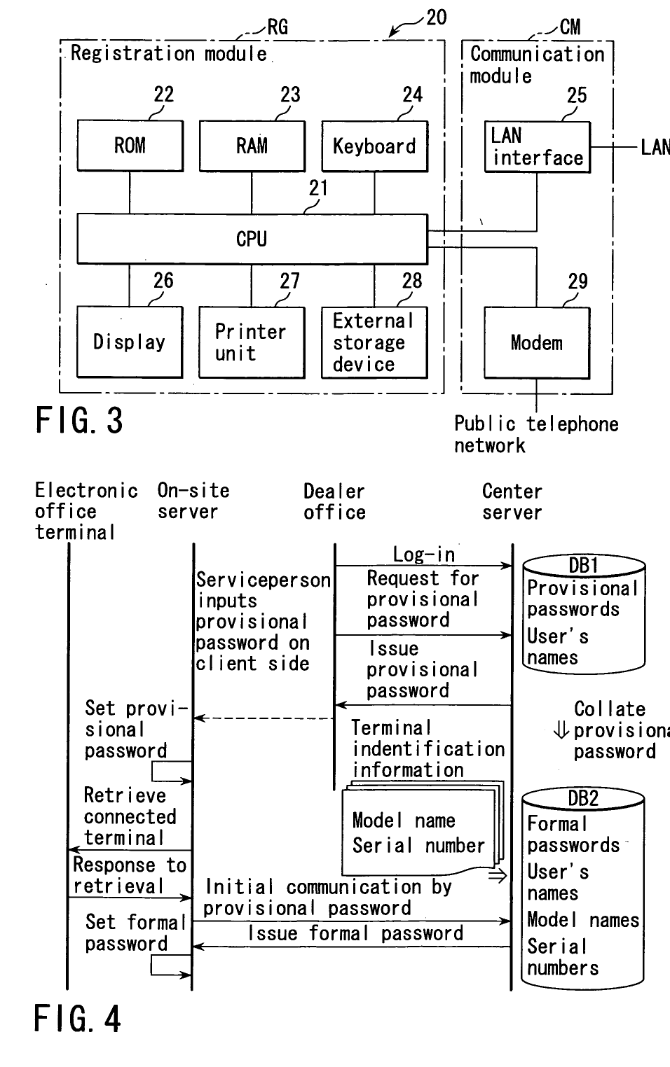

FIG. 3 shows an example of the circuit configuration of the on-site server 20. The on-site server 20 includes a CPU 21, ROM 22, RAM 23, keyboard 24, LAN interface 25, display 26, printer 27, external storage device 28 and modem 29. The CPU 21 performs a control process to control the whole operation of the on-site server 20. The ROM 22 stores fixed data and a control program of the CPU 21 and the RAM 23 temporarily stores input and output data of the CPU 21. The keyboard 24 inputs various commands and data required for the control process. The LAN interface 25 is an interface that connects the CPU 21 to the LAN and makes data communication with the electronic office terminal 10 or the like via the LAN. The display 26 displays various characters and images corresponding to data obtained by the control process and the printer 27 prints characters and images corresponding to data obtained by the control process. The external storage device 28 is used to store application software such as a terminal information registration program and a program that provides the web site and data the amount of which exceeds the storage capacity of the ROM 22 and RAM 23. For example, the storage device 28 includes a hard disk drive, COM drive, floppy disk drive and the like. Like the modem 19 on the electronic office terminal 10 side, the modem 29 is an interface that connects the CPU 21 to the public telephone network, for example, and makes data communication via the public telephone network.

At the time of execution of the terminal information registration program, the on-site server 20 is caused to function as a terminal information registration apparatus. In this case, the LAN interface 25 and modem 29 form a communication module CM connected to the center server 30 via Internet. Further, the CPU 21, ROM 22, RAM 23, keyboard 24, display 26, printer 27 and external storage device 28 form a registration module RG which registers management object terminal information into the center server 30 via the communication module CM. In the registration module RG, the CPU 21 sets a provisional password issued to an authorized user of electronic office terminals 10 as provisional access code into the communication module CM and establish an initial communication for registering terminal identification information items of the electronic office terminals 10 as the management object terminal information into the center server 30. In addition, the CPU 21 causes the external storage device 28 to hold a formal password sent back as a formal access code from the center server 30 as the result of registration of the terminal identification information. Further, the CPU 21 sets the formal password in the communication module CM upon request from the center server 30 and establishes a communication for registering the running status information of the electronic office terminals 10 as the management object terminal information. In this case, the terminal identification information includes the serial numbers and the model names of the electronic office terminals 10. Further, the running status information contains the number of copy sheets indicating the number of operations in the copy function attained by a combination of the scanner unit 16 and printer unit 17 of the electronic office terminal 10.

The center server 30 includes hardware substantially identical to that of the on-site server 20. The center server 30 is configured to request entry of the name of an authorized user of the electronic office terminals 10 which are newly installed, provide a dealer site that issues a provisional password to the authorized user whose name is entered according to the above request on Internet, and store a combination of the name of the authorized user and the provisional password into a provisional password management database DB1. For example, the provisional password is deleted together with the authorized user's name from the database DB1 after a preset period of time such as approximately one week, and therefore, the term of validity of the provisional password coincides with the preset period of time. Further, the center server 30 receives a provisional password transmitted from the on-site server 20 and collates the provisional password with the database DB1. Further, the center server 30 is configured to permit an initial communication for registering terminal identification information when the provisional password is present in the database DB1 and refuse the initial communication when the provisional password is not present. In addition, the center server 30 is configured to receive terminal identification information items of all the electronic office terminals 10 registered in the initial communication, issue a formal password to the on-site server 20 as the registration result and store the formal password, authorized user's name and all the terminal identification information items into a terminal management database DB2. Further, the center server 30 is configured to periodically repeats a process for issuing a request for the running status information items of all the electronic office terminals 10 to the on-site server 20, receiving a formal password transmitted from the on-site server 20 according to the above request, collating the formal password with the database DB2, permitting a communication for registering running status information only when the formal password is present in the database DB2, and storing the running status information registered in the above communication in the database DB2.

FIG. 4 shows the flow of a process for acquiring the formal password. When a plurality of electronic office terminals 10 are newly installed on the client side, a serviceperson of the dealer who is in charge of installation logs in the dealer site on Internet from a general purpose computer in the dealer office, enters an authorized user's name of the electronic office terminals 10 to request a provisional password. If a provisional password is issued on the dealer site side in response to the request, the serviceperson goes to the client side to input the provisional password by use of the keyboard 24 of the on-site server 20. Then, the provisional password is set together with an Internet address of the center server 30 in the LAN interface 25 as a communication parameter. Next, a general call is issued from the on-site server 20 side to search for the electronic office terminals 10 on the LAN and all the electronic office terminals 10 output terminal identification information items in response to the call. When the terminal identification information items of the electronic office terminals 10 are temporarily stored in the RAM 23, the initial communication with the center server 30 is established by the provisional password. In the initial communication, the terminal identification information items of all the electronic office terminals 10 are retrieved from the RAM 23 and registered into the center server 30 via Internet. As a result, the formal password is issued from the center server 30.

In the present embodiment, the terminal identification information items of electronic office terminals 10 are registered into the center server 30 as management object terminal information in the communication established by use of the provisional password. Since the provisional password is issued to the authorized user, the serviceperson of the dealer who is in charge of installation can newly acquire or re-acquire the password simply by registering the authorized user and does not have to deal with the terminal identification information of each of the electronic office terminals 10. Therefore, a failure occurring in the process of registering the terminal identification information can be eliminated.

Further, terminal identification information can be registered for a plurality of electronic office terminals 10 simply by acquiring one provisional password. Therefore, even when the number of electronic office terminals 10 is extremely large, it will not impose a heavy load on the serviceperson of the dealer in charge of installation. If the password is lost before installation of the electronic office terminals 10, the terminal identification information of each of the electronic office terminals 10 is not registered in the center server 30 as management object terminal information at this time point. Therefore, the center server 30 does not need to perform any process relating to the terminal identification information when the provisional password is lost.

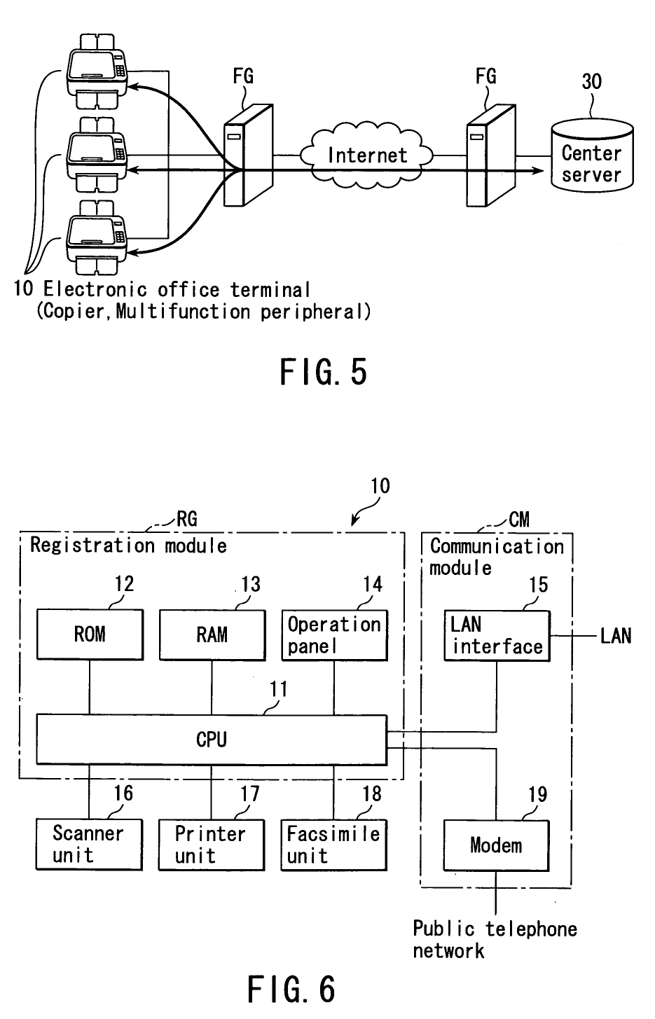

A remote management system according to a second embodiment of this invention will be described below with reference to FIGS. 5 to 7. The remote management system is configured in the same manner as that of the first embodiment except a configuration that registers terminal identification information and running status information irrespective of the on-site server 20 shown in FIG. 1. Therefore, in FIGS. 5 to 7, portions which are the same as those of the first embodiment are denoted by the same reference symbols and the detail explanation thereof is omitted.

FIG. 5 schematically shows the configuration of the remote management system. In FIG. 5, a plurality of electronic office terminals 10 are installed on the client side and a center server 30 is installed at the service base of the manufacturer. The plurality of electronic office terminals 10 are commonly used on a local area network (LAN) and connected via a firewall gateway FG to Internet used as a communication network. The center server 30 is a computer that manages the running statuses of the electronic office terminals and is connected via a firewall gateway FG to Internet in the same manner as the client side. In this case, each of the electronic office terminals 10 has a function of registering its own running status information into the center server 30 upon request from the center server 30.

FIG. 6 shows an example of the circuit configuration of the electronic office terminal 10. The electronic office terminal 10 corresponds to a multifunction peripheral having a combination of a scanner function, printer function and facsimile function. Like the first embodiment, the terminal 10 includes a CPU 11, ROM 12, RAM 13, operation panel 14, LAN interface 15, scanner unit 16, printer unit 17, facsimile unit 18 and modem 19. A terminal information registration apparatus which is the same as that of the first embodiment is incorporated in the electronic office terminal 10. That is, the LAN interface 15 and modem 19 form a communication module CM connected to the center server 30 by Internet. Further, the CPU 11, ROM 12, RAM 13 and operation panel 14 form a registration module RG which registers management object terminal information into the center server 30 via the communication module CM. In the registration module RG, the CPU 11 sets a provisional password issued as a provisional access code to the authorized user of the electronic office terminal 10 into the communication module CM and establishes an initial communication for registering terminal identification information of the electronic office terminal 10 as the management object terminal information into the center server 30. In addition, the CPU 11 causes the RAM 23 to hold a formal password sent back as a formal access code from the center server 30 as the result of registration of the terminal identification information. Further, the CPU 11 sets the formal password in the communication module CM upon request from the center server 30 and establishes a communication for registering the running status information of the electronic office terminal 10 as the management object terminal information. In this case, part of the RAM 23 is configured by a rewritable nonvolatile memory to continuously hold the formal password. The terminal identification information includes the serial number and the model name of the electronic office terminal 10. Further, the running status information contains the number of copy sheets indicating the number of operations in the copy function attained by a combination of the scanner unit 16 and printer unit 17 of the electronic office terminal 10.

The center server 30 includes hardware substantially identical to that of the first embodiment. It is configured to request entry of the name of an authorized user of the electronic office terminal 10 which is newly installed, provide a dealer site that issues a provisional password to the authorized user whose neme is entered according to the above request on Internet, and store a combination of the name of the authorized user and the provisional password in a provisional password management database DB1. Further, the center server 30 receives a provisional password transmitted from each electronic office terminal 10 and collates the provisional password with the database DB1. Further, the center server 30 is configured to permit an initial communication for registering terminal identification information when the provisional password is present in the database DB1 and refuse the initial communication when the provisional password is not present. In addition, the center server 30 is configured to receive terminal identification information of the electronic office terminal 10 registered in the initial communication, issue a formal password to the electronic office terminal 10 as the registration result and store the formal password, authorized user's name and terminal identification information in a terminal management database DB2. Further, the center server 30 is configured to periodically repeat a process for issuing a request for the running status information of the electronic office terminal 10, receiving a formal password transmitted from the electronic office terminal 10 according to the above request, collating the formal password with the database DB2, permitting a communication for registering running status information only when the formal password is present in the database DB2, and storing the running status information registered in the above communication in the database DB2.

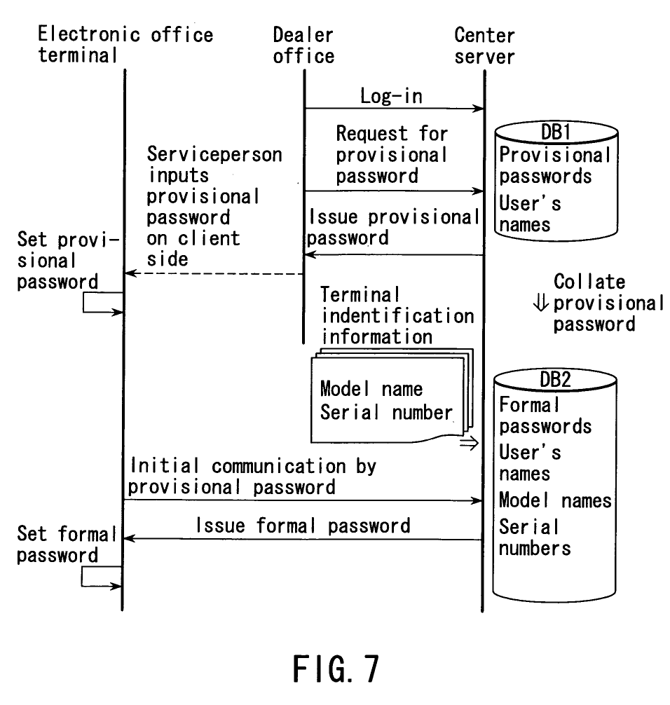

FIG. 7 shows the flow of a process for acquiring the formal password. When a plurality of electronic office terminals 10 are newly installed on the client side, a serviceperson of the dealer who is in charge of installation logs in the dealer site on Internet from a general purpose computer in the dealer office, enters an authorized user's name of the electronic office terminals 10 to request a provisional password. If a provisional password is issued on the dealer site side in response to the request, the serviceperson goes to the client side to input the provisional password by use of the operation panel 14 of each electronic office terminal 10. Then, the provisional password is set together with an Internet address of the center server 30 in the LAN interface 15 as a communication parameter, and the initial communication with the center server 30 is established by the provisional password. The terminal identification information of each electronic office terminal 10 is held in the ROM 22. In the initial communication, the terminal identification information is retrieved from the ROM 22 and registered into the center server 30 via Internet. As a result, the formal password is issued from the center server 30.

In the present embodiment, the terminal identification information of the electronic office terminal 10 is registered into the center server 30 as management object terminal information in the communication established by use of the provisional password. Therefore, the same effect as that of the first embodiment can be attained. Since the provisional password is issued to the authorized user, the serviceperson of the dealer who is in charge of installation can newly acquire or re-acquire the provisional password simply by registering the authorized user and does not have to deal with the terminal identification information of each electronic office terminal 10. Therefore, a failure occurring in the process of registering the terminal identification information can be eliminated.

This invention is not limited to the above embodiments and can be variously modified without departing from the technical scope thereof.

In each of the above embodiments, the electronic office terminal 10 is explained as the multifunction peripheral that includes the scanner unit 16, printer unit 17 and facsimile unit 18. However, the terminal 10 may be configured to include at least one of the scanner unit 16, printer unit 17 and facsimile unit 18.

In the first and second embodiments, the LAN interfaces 25 and 15 each of which registers the terminal identification information in the center server 30 via Internet are used. However, each of the modems 29 and 19 can be used for registering the terminal identification information in the center server 30 via the public telephone network.

Further, in the first embodiment, a case wherein the program for attaining the function of this invention is prepared in the on-site server 20 is explained. However, this is not limitative and the same program can be downloaded from the network or read out from a storage medium and installed into the system. At the time of using the storage medium, any storage medium such as a floppy disk, hard disk, optical disk (for example, CD-ROM), magneto-optical disk (for example, MO) or semiconductor memory which can store the program and from which a computer can read out information can be used irrespective of the type thereof.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A terminal information registration apparatus comprising:
a communication module connected to a terminal management apparatus by a communication network; and
a registration module that registers management object terminal information into said terminal management apparatus via said communication module, said registration module being configured to set a provisional access code issued to an authorized user into said communication module and establish a communication for registering terminal identification information of one or more electronic office terminals as the terminal information.

2. The terminal information registration apparatus according to claim 1, wherein said registration module is configured to hold a formal access code sent back from said terminal management apparatus as a result of registration of the terminal identification information, set the formal access code into said communication module and establish a communication for registering running status information of said one or more electronic office terminals as the-management object terminal information.

3. The terminal information registration apparatus according to claim 1, wherein said registration module is incorporated together with said communication module into a server computer connected to said one or more electronic office terminals by a local area network and configured to collect the terminal identification information from said one or more electronic office terminals.

4. The terminal information registration apparatus according to claim 1, wherein said registration module is incorporated into each electronic office terminal together said the communication module.

5. The terminal information registration apparatus according to claim 1, wherein said electronic office terminal includes at least one of a scanner unit, printer unit and facsimile unit.

6. A terminal information registration method which connects a communication module to a terminal management apparatus by a communication network and registers management object terminal information into said terminal management apparatus via said communication module, comprising:
setting a provisional access code issued to an authorized user into said communication module; and
establishing a communication for registering terminal identification information of one or more electronic office terminals as the management object terminal information.

7. The terminal information registration method according to claim 6, further comprising:
holding a formal access code sent back from said terminal management apparatus as a result of registration of the terminal identification information;
setting the formal access code into said communication module; and
establishing a communication for registering running status information of said one or more electronic office terminals as the management object terminal information.

8. The terminal information registration method according to claim 6, wherein registration of the management object terminal information is performed as a result of collection of the terminal identification information from said one or more electronic office terminals by use of a server computer connected to said one or more electronic office terminals by a local area network.

9. The terminal information registration method according to claim 6, wherein registration of the management object terminal information is performed in each electronic office terminal.

10. A terminal information registration program which is executed by a registration module incorporated together with a communication module into a server computer connected to one or more electronic office terminals by a local area network to connect said communication module to a terminal management apparatus by a communication network and operate said registration module to register management object terminal information into said terminal management apparatus via said communication module, said program comprising:
setting a provisional access code issued to an authorized user into said communication module; and
establishing a communication for registering terminal identification information of said one or more electronic office terminals as the management object terminal information.

11. The terminal information registration program according to claim 10, further comprising:
holding a formal access code sent back from said terminal management apparatus as a registration result of the terminal identification information;
setting the formal access code into said communication module; and
establishing a communication for registering running status information of said one or more electronic office terminals as the management object terminal information.

12. The terminal information registration program according to claim 10, wherein registration of the management object terminal information is performed as a result of collection of the terminal identification information from said one or more electronic office terminals.
